(19) United States
(12) Patent Application Publication
(10) Pub. No.: US 2025/0315599 A1
(43) Pub. Date: Oct. 9, 2025

(54) SYSTEMS AND METHODS FOR AUTOMATED TRANSLATION OF AND CREATION OF DOCUMENTS

(71) Applicant: Precog Labs LLC, San Diego, CA (US)

(72) Inventor: Adam Gillespie, San Diego, CA (US)

(21) Appl. No.: 19/169,914

(22) Filed: Apr. 3, 2025

Related U.S. Application Data
(60) Provisional application No. 63/574,064, filed on Apr. 3, 2024.
(60) Provisional application No. 63/574,081, filed on Apr. 3, 2024.
(60) Provisional application No. 63/574,093, filed on Apr. 3, 2024.

(51) Int. Cl. G06F 40/166; G06F 40/247; G06F 40/58

(52) U.S. Cl. CPC G06F 40/166; G06F 40/247; G06F 40/58

(57) ABSTRACT

A method comprising using at least one hardware processor to: receive instruction to generate a particular type of document comprising a plurality of containers, and wherein the document has a primary language and a secondary language; generate the document with the plurality of containers; receive text in either the primary language for certain of the plurality of containers; populate the text into the corresponding containers of the plurality of containers; automatically translate the text into the secondary language and populate the translated text into the corresponding containers of the plurality of containers; and present the test to a user via a user interface for review and editing.

### CROSS-REFERENCE TO RELATED APPLICATIONS

This application claims priority to U.S. Provisional Application Nos. 63/574,064, entitled, “SYSTEMS AND METHODS FOR AUTOMATED TRANSLATION OF AND CREATION OF DOCUMENTS”, filed on Apr. 3, 2024, 63/574,081, entitled “SYSTEMS AND METHODS FOR AUTOMATED TRANSLATION, EDITING AND CREATION OF DOCUMENTS”, filed Apr. 3, 2024, and 63/574,093, entitled “SYSTEMS AND METHODS FOR AUTOMATED SUGGESTION, TRANSLATION, EDITING AND CREATION OF DOCUMENTS”, filed Apr. 3, 2024, all of which are incorporated herein by reference as if set forth in full.

### BACKGROUND

### Field of the Invention

The embodiments described herein are generally directed to multi-lingual documents, and more particularly to automated translation and creation of multi-lingual documents.

### Description of the Related Art

Often contracts or other agreements need to be drafted in more than one language. This typically requires that the document or agreement be drafted in one language, and then translated into another. While inefficient to begin with, another problem with this conventional approach is that at least one of the parties often cannot determine whether the translation is accurate and captures the intent of the author and/or parties to the agreement. Direct translation is not always possible and moreover, even if directly translated, meaning, context, emphasis, etc., in one language may not be conveyed in another, even with a direct translation.

Thus, conventional methods for producing such documents are inefficient, and can produce errors or inaccuracies.

### SUMMARY

Accordingly, systems, methods, and non-transitory computer-readable media are disclosed to produce translations in an efficient manner that reduces errors and inaccuracies.

In an embodiment, a method comprising using at least one hardware processor to: receive instruction to generate a particular type of document comprising a plurality of containers, and wherein the document has a primary language and a secondary language; generate the document with the plurality of containers; receive text in either the primary language for certain of the plurality of containers; populate the text into the corresponding containers of the plurality of containers; automatically translate the text into the secondary language and populate the translated text into the corresponding containers of the plurality of containers; and present the test to a user via a user interface for review and editing.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment; and

FIGS. 3-32 are screen shots for a user interface implemented by the platform of FIG. 1 for automated creation and translation of documents, according to an embodiment.

### DETAILED DESCRIPTION

In an embodiment, systems, methods, and non-transitory computer-readable media are disclosed for automated translation and creation of multi-lingual documents.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

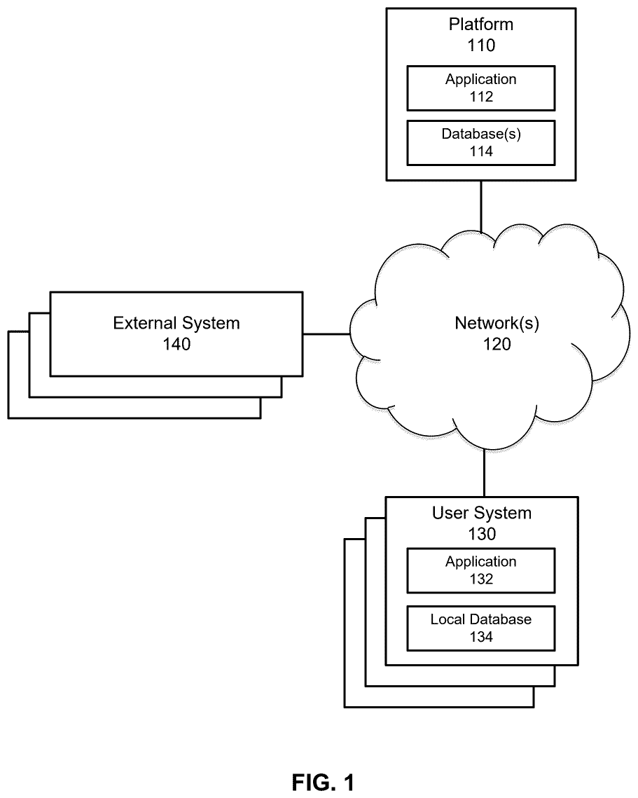

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes (e.g., methods or functions, implemented as software modules) described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes (e.g., methods and functionality), storage, and/or the like, described herein. For example, in such an embodiment, a client application 132, executing on one or more user system(s) 130, may interact with a server application 112 executing on platform 110 to execute one or more or a portion of one or more of the various process(es) described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes (e.g., methods or functions) described herein.

### 1.2. Example Processing Device

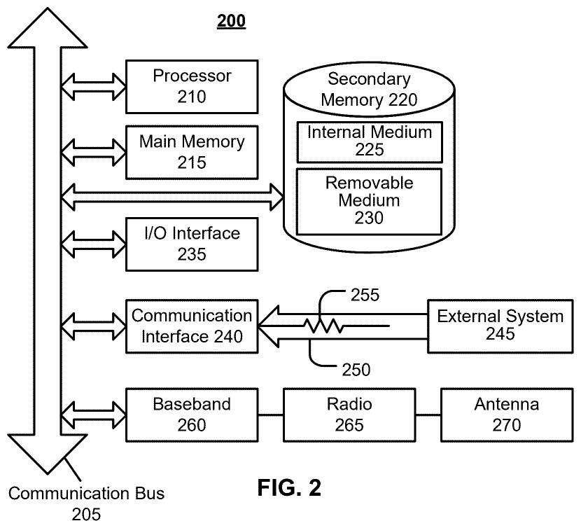

FIG. 2 is a block diagram illustrating an example wired or wireless system 200 that may be used in connection with various embodiments described herein. For example, system 200 may be used as or in conjunction with one or more of the processes (e.g., to store and/or execute the software), including any methods or functions, described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various process(es) of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various process(es) of the disclosed embodiments.

### 2. Process Overview

Embodiments of processes for automated translation and creation of multi-lingual documents will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1 Home Screen

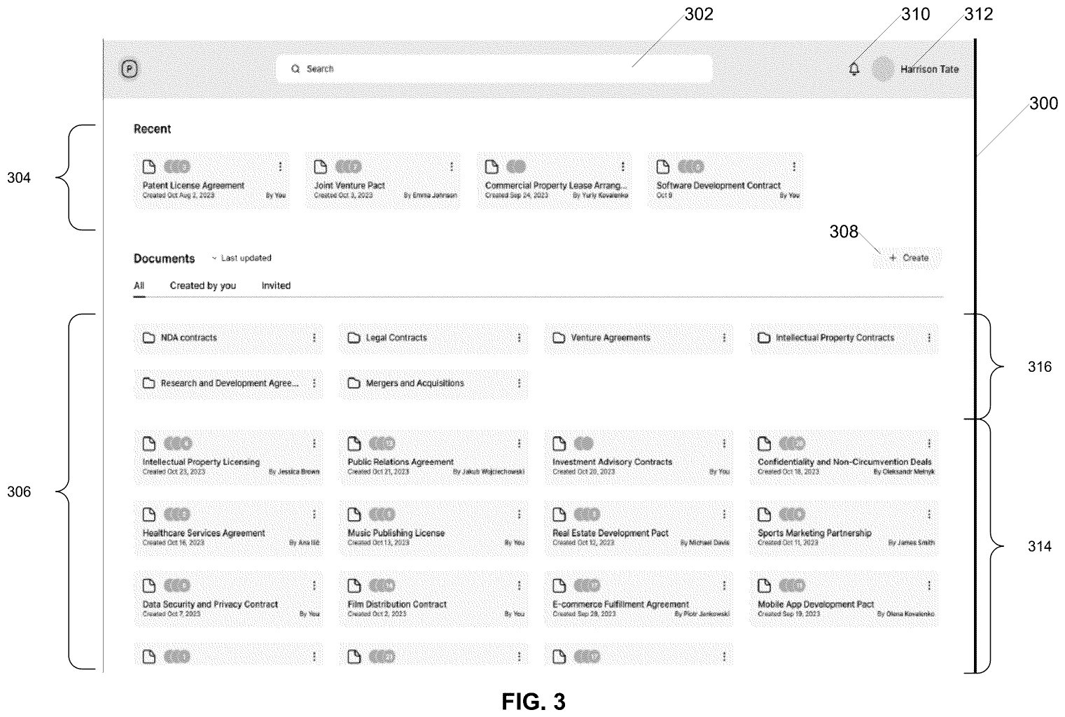

First, an example home screen 300 for an automated translation and creation of multi-lingual documents application 132 will be described, with reference to FIGS. 3-11, before describing the process of creating a document using the application 132 and/or 112. In the example of, e.g., FIG. 3, home screen 300 comprises a document area 306 that list and allows browsing and access to the documents 314 and files 316 created on the system related to a particular user. As can be seen, the documents in this example can be sorted by the documents created by the user, document not created by the user, but with respect to which the user has been invited to edit and/or review, and all the documents related to the user. In certain embodiments, the user can be associated with a group or organization and can have access to all documents related thereto. Also, in this example, the documents in area 306 are sorted from top to bottom by the date of creation of the documents. Home screen 300 also comprises a recent documents area 304, which displays, e.g., the four most recent documents edited and/or accessed by the user.

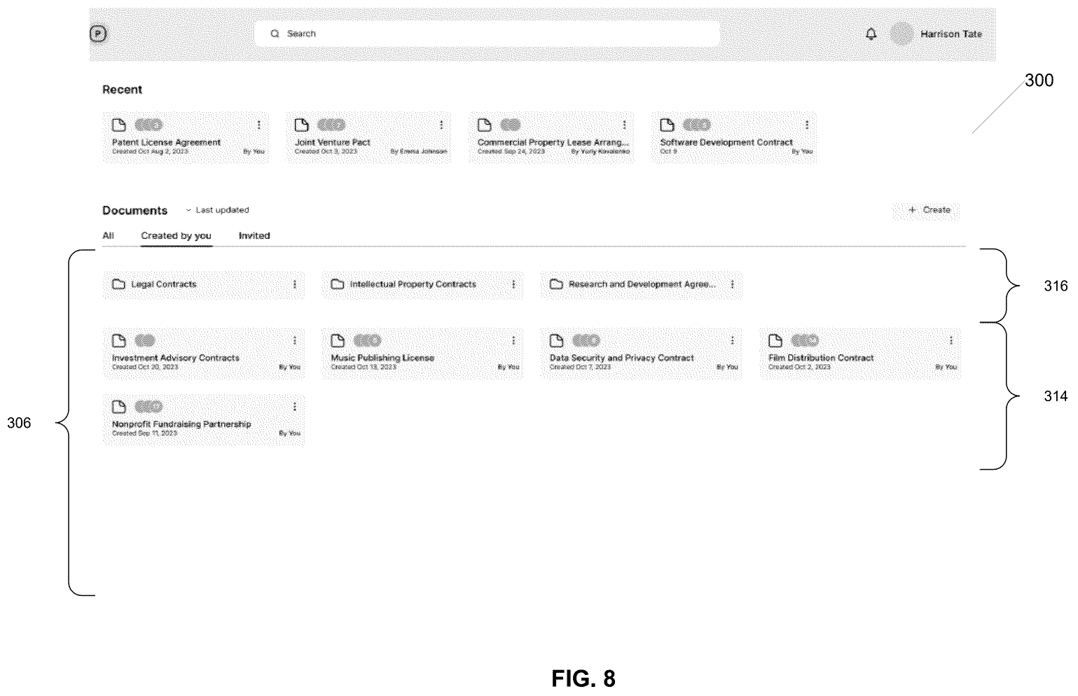

As can be seen, the documents in this example can be sorted by the documents created by the user, document not created by the user, but with respect to which the user has been invited to edit and/or review, and all the documents related to the user. Thus, as can be seen in FIG. 8, the user can select the “created by you” option and only those documents 314 and folders 316 created by the user will appear in document area 306.

Each document 314 in document area 306 can include an icon in the left corner indicating that it is a document, as opposed, e.g., to a file, and a number indicating the number of people collaborating on the documents. In certain embodiments, the user can see a list of those collaborators by clicking on the number. The name of the creator of the document can also be included, e.g., in the lower right corner.

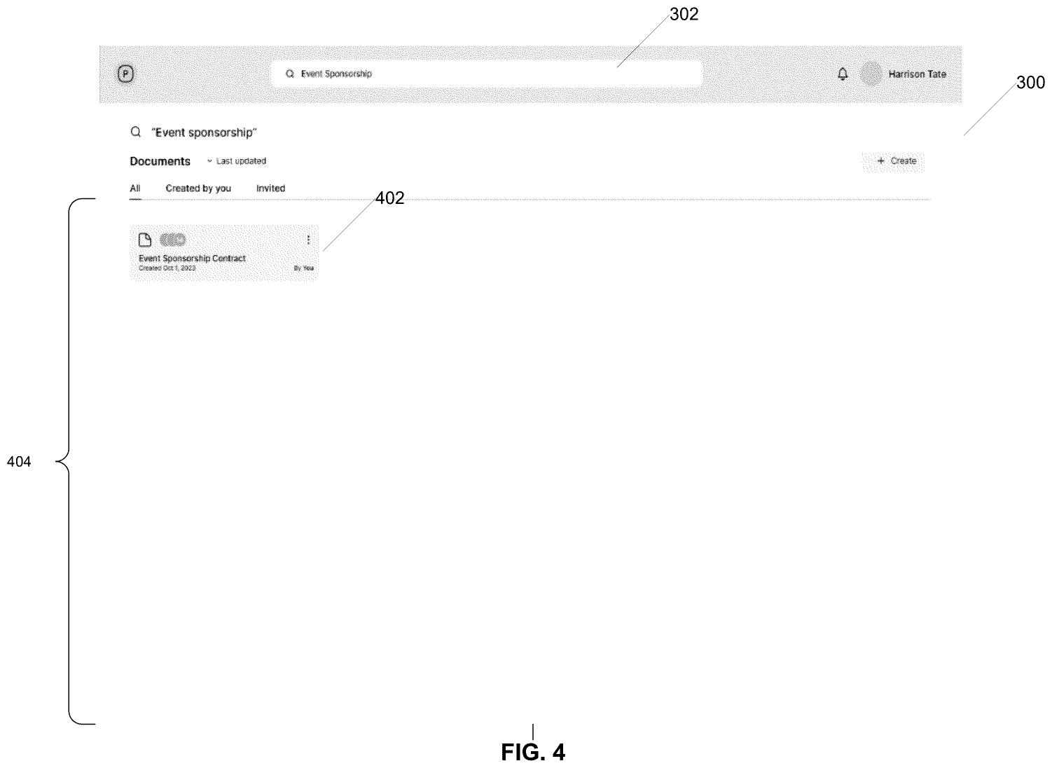

Home screen 300 can also comprise a, e.g., button 308 that can be used to quickly start the creation of a new document, as described in more detail below, as well as a search bar 302 that allows the user to search for specific documents as illustrated in FIG. 4. In FIG. 4 it can be seen that a search for a document with “Event Sponsorship” in the title was launched, which resulted in document 402 being listed in search result area 404.

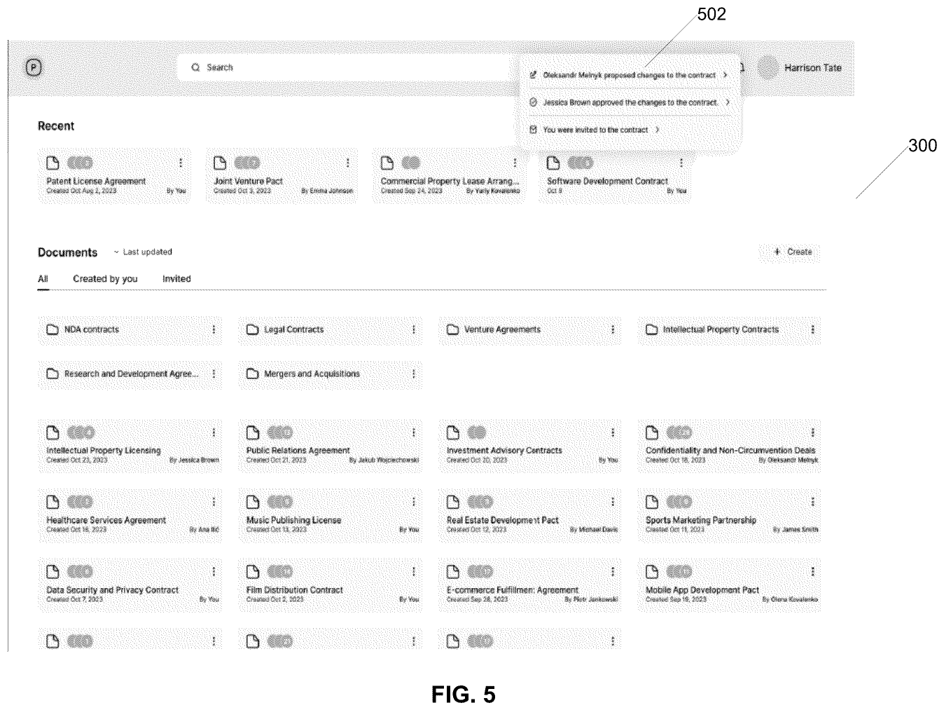

A user can also get notifications from the system and/or other users. As can be seen in FIG. 3, a notification button 310 can allow access to such notifications. When the user clicks on button 310, notifications can be displayed, e.g., in sub-window 502 as illustrated in FIG. 5. The user can then select a notification to review and potentially act or respond.

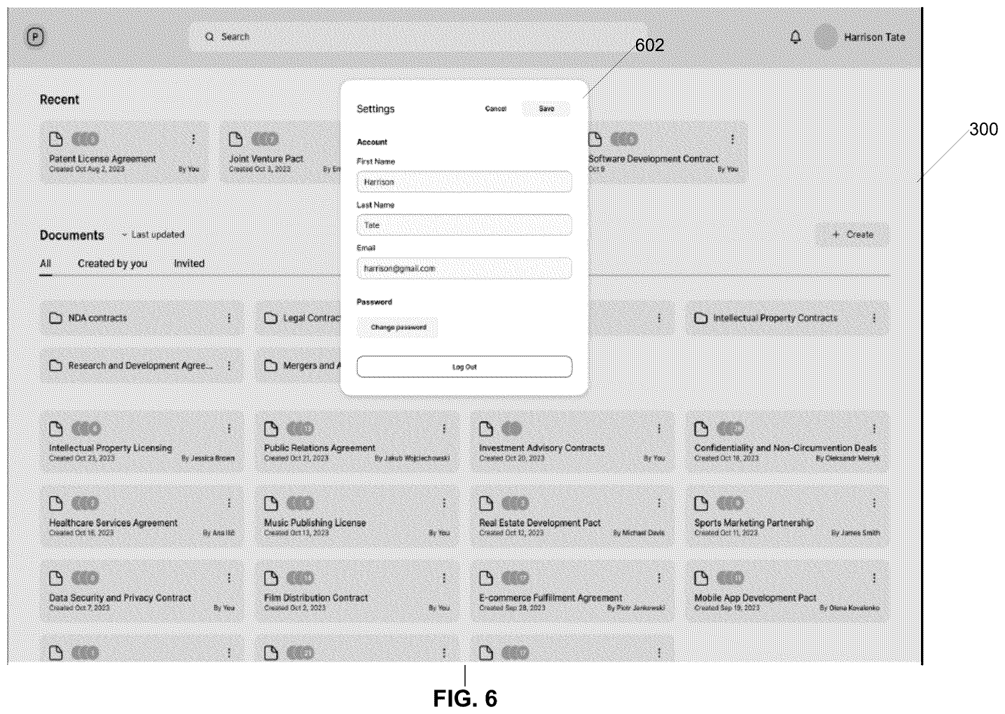

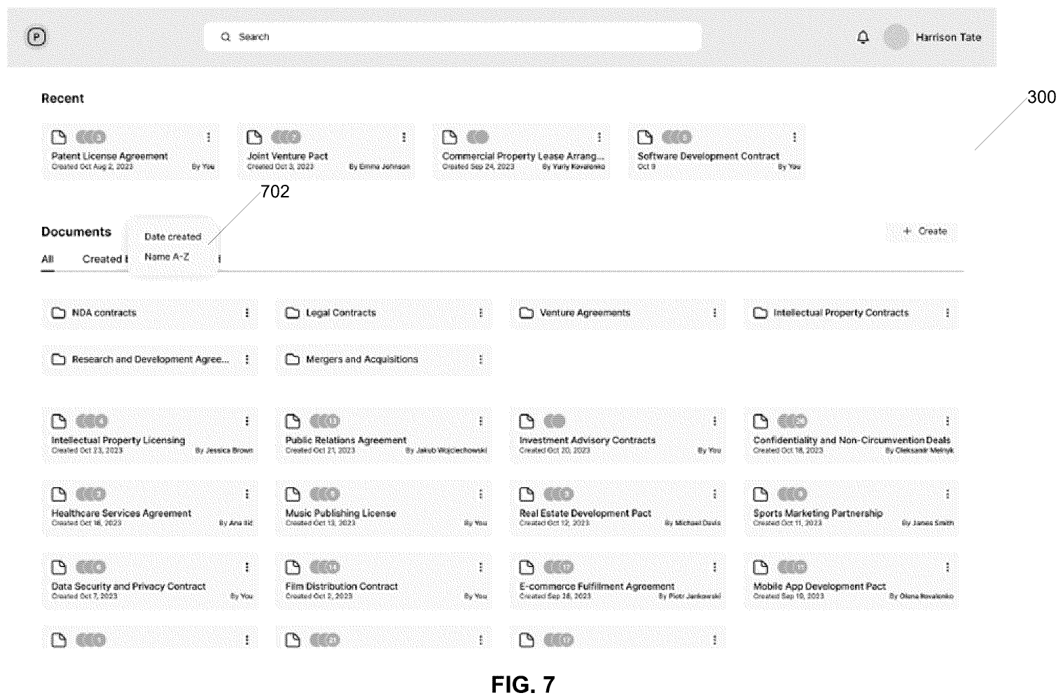

The user can also access their profile by selecting icon 312, which as can be seen in FIG. 6 will pop up a window 602 that allows the user to edit their profile and/or logout. Further, while the documents in area 304 are show as being sorted by the date created, by clicking on that selection other sorting options can be selected, e.g., via op-up menu 702 illustrated in FIG. 7.

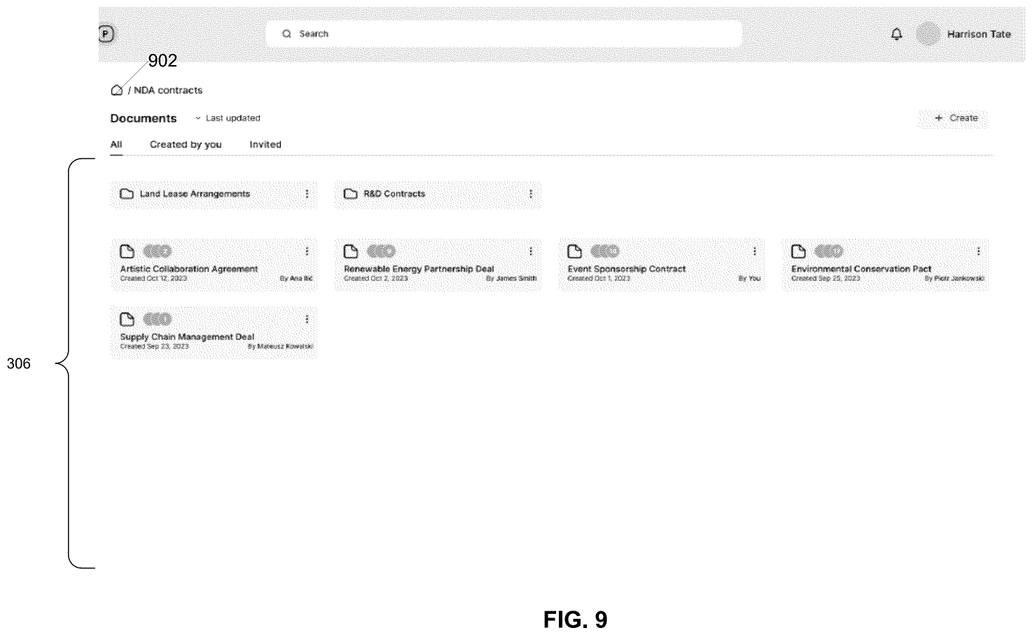

If the user clicks on a folder in area 306, then the sub-folders and documents stored in the folder will be displayed as illustrated in FIG. 9. In this example, to get back to the home screen, the user can click on icon 902, which also identifies what folder the user is presently in.

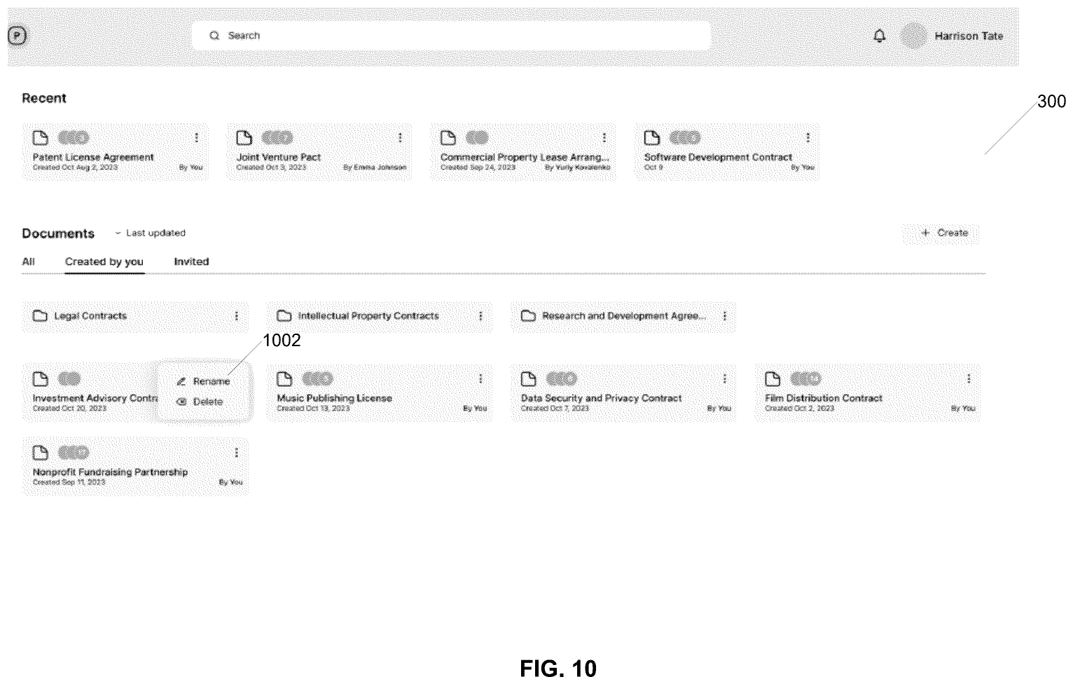

As illustrated in FIG. 10, the user can click on, e.g., the ellipses associated with a particular document and be offer option via window 1002 to delete the document or adjust the document profile, such as renaming the document.

### 2.2 Document Creation

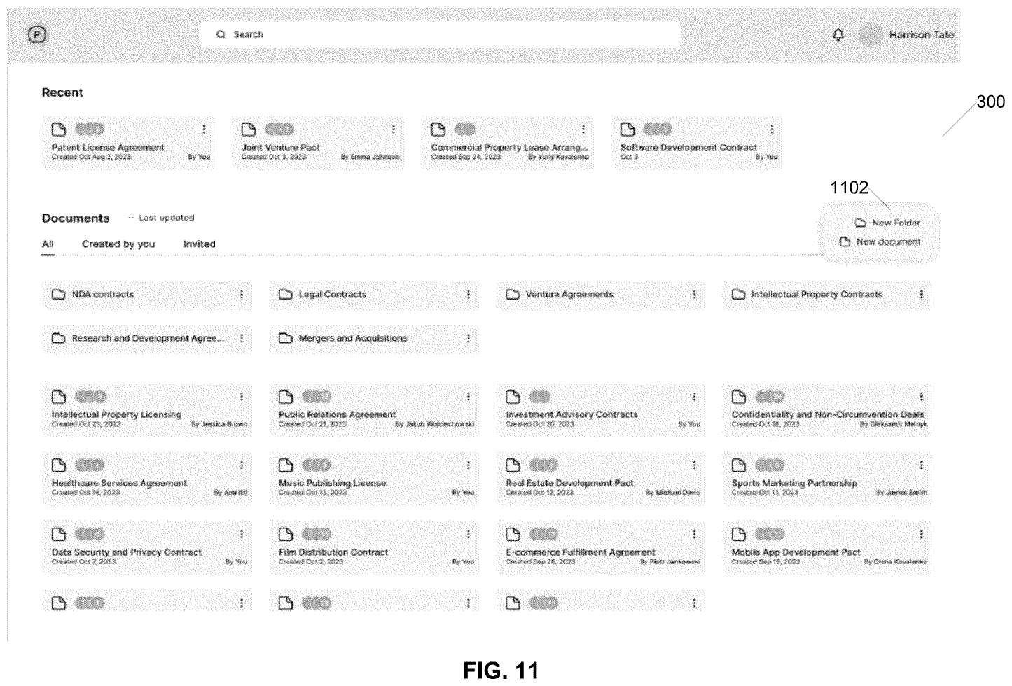

The process of creating a document will now be described starting the screen shot of FIG. 11. When the user selects the create button 308, a dialogue box 1102 can be presented allowing the user to select whether to generate a new folder, or a new document. Obviously, to create a new document, the user will select new document.

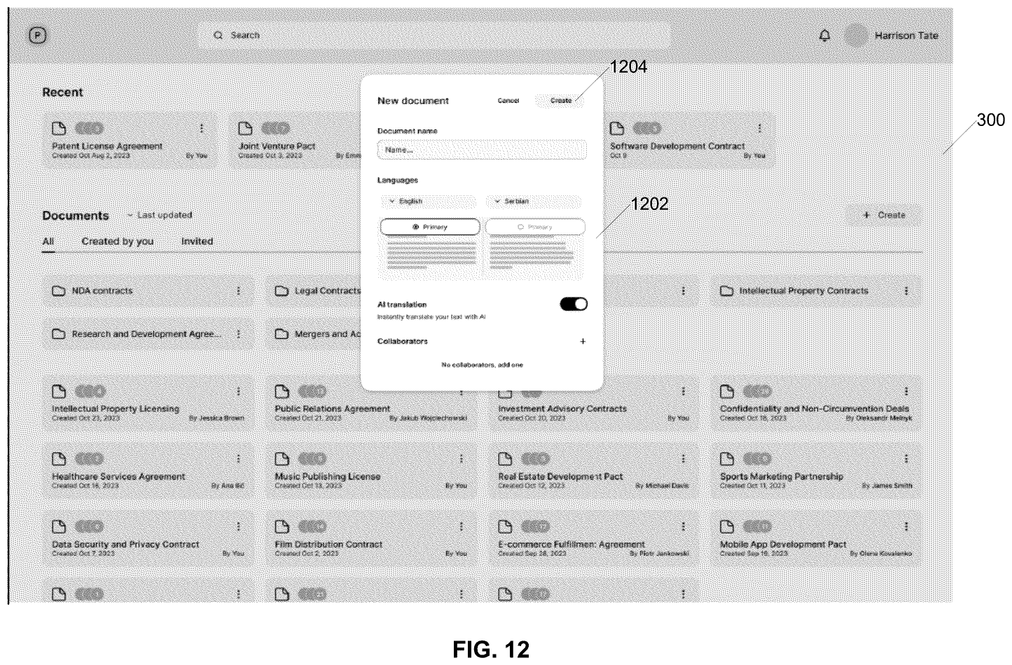

As can be seen in FIG. 12, once the user selects new document, a window 1202 can be displayed that allows the user to select a name for the document, select a language for each “side’ of the document, select which language is the primary language, select whether the application 132 and/or 112 will automatically translate the text, e.g., typed in the primary language into the secondary language, and invite collaborators.

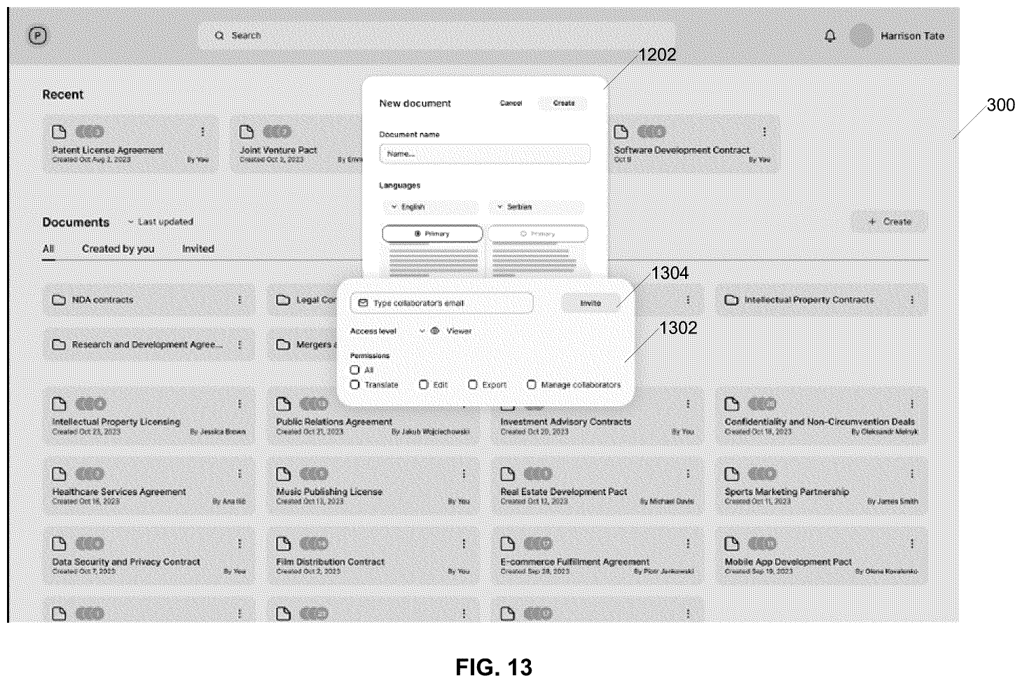

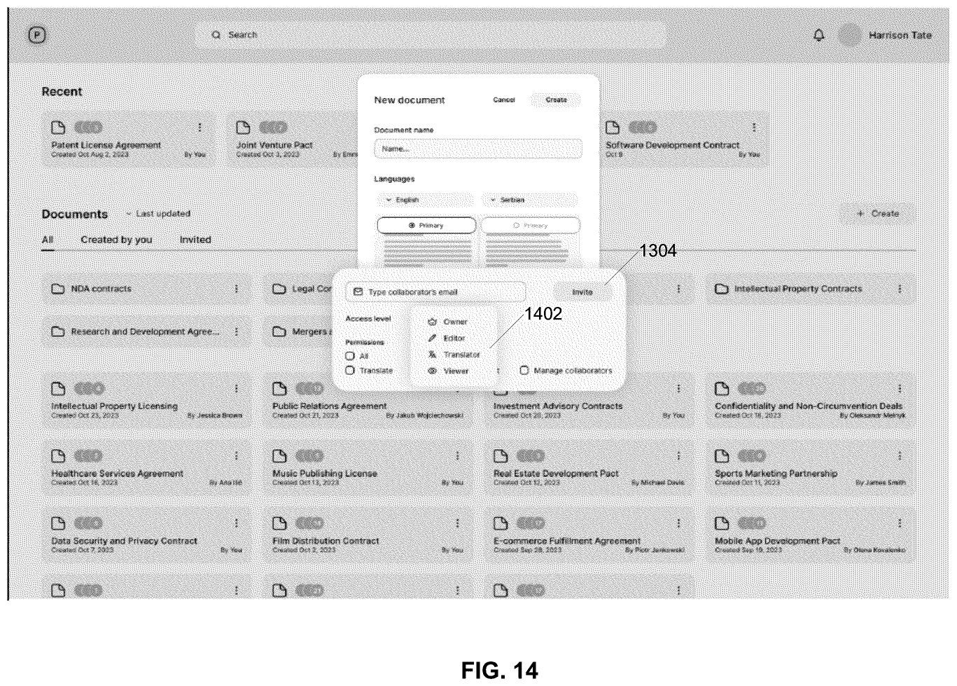

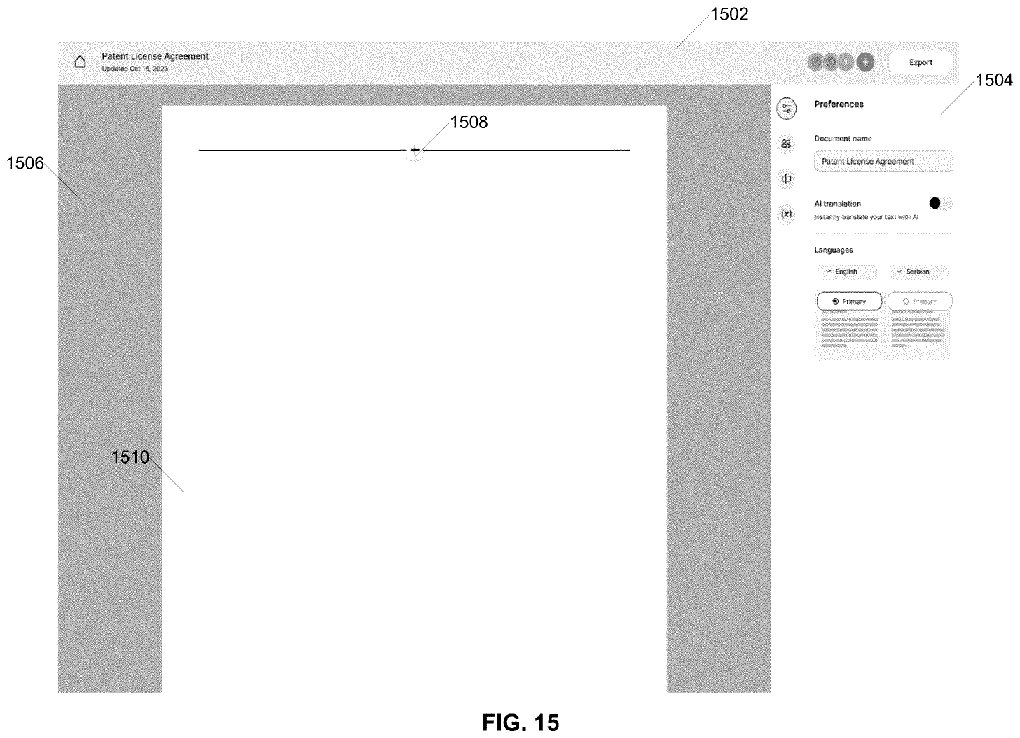

When the user elects to add a collaborator, a window 1302 can be presented as illustrated in FIG. 13. In window 1302, the user can provide the collaborator's name, access level and permissions. In selecting the access level, a window 1402 can be presented as illustrated in FIG. 14, that allows the user to select a role, with associated access permissions. The user can then invite the collaborator by, e.g., clicking the invite button 1304.

Once the document has been named, languages selected, translation option made, and collaborators created and invited, then the user can start creating the document by, e.g., selecting the create button 1204.

### 2.3 Document Editor

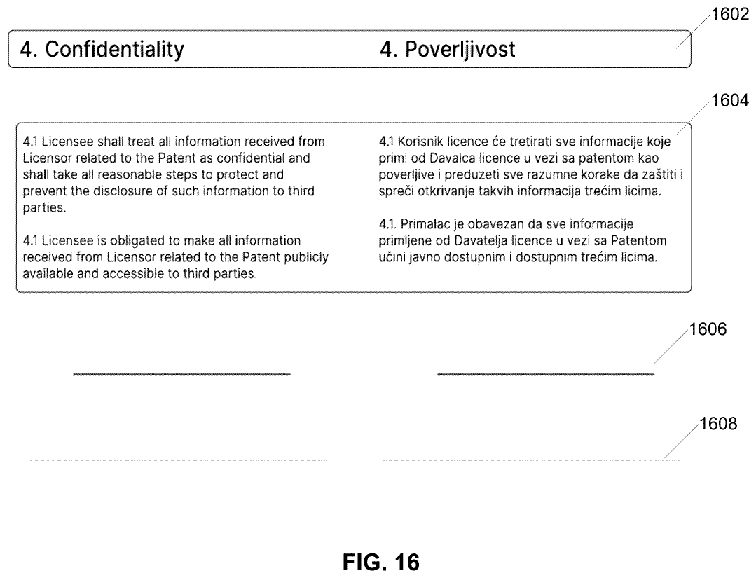

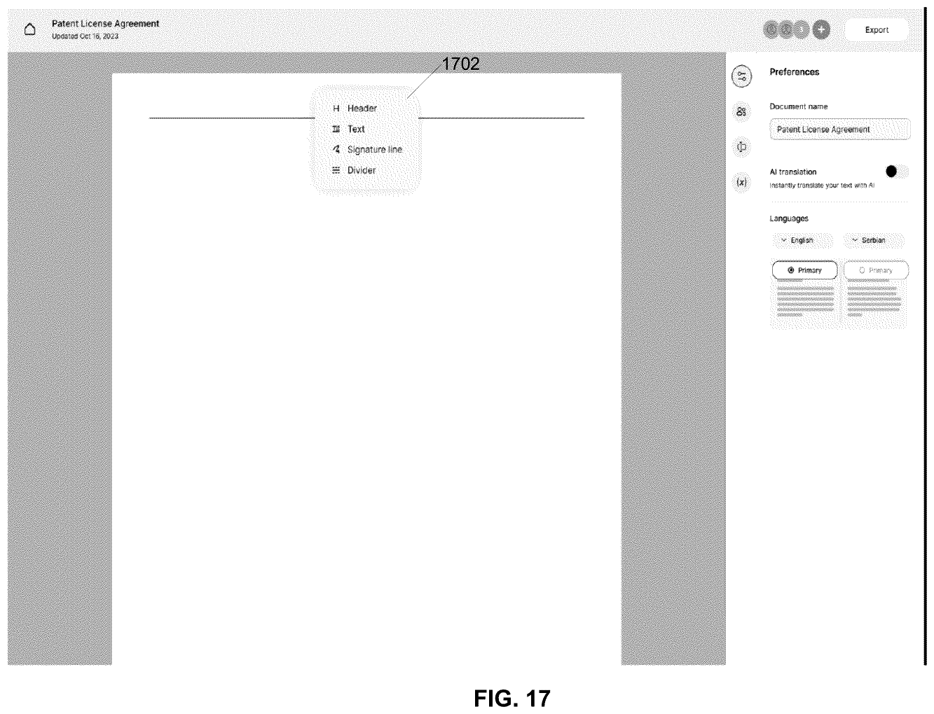

Once the user elects to create a new document, then the document editor screen 1502 can be displayed. As can be seen, in tis example, the document editor screen 1502 comprises the preference window 1504 that displays the preferences selected during document creation as well as the editor window 1506. The document template itself is made up of containers. For example, there can be four containers: a header container 1602, a text container 1604, a signature line container 1606, and a divider container 1608 as illustrated in FIG. 16. In certain embodiments, the containers can be edited, moved, and translated separately.

The header 1602 and text 1604 container can be basic text, but with differences such as font, font size, boldness, etc., which can all be selectable by the user. In this example, the signature line container 1606 can be represented by solid lines and serves as the designated space for signatures. Again, in this example, the divider container 1608 comprises dashed and grayed lines, and serves the purpose of dividing the different containers, i.e., portions of the document.

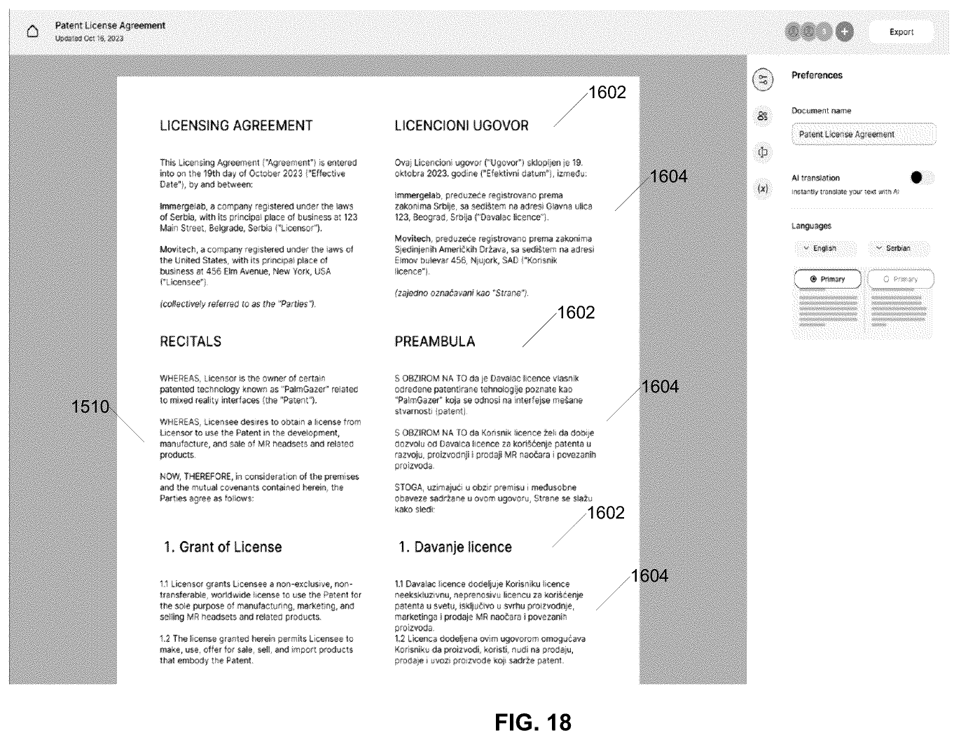

The user can add a container by selecting the plus button 1508. When button 1508 is selected a window 1702 can be displayed that allows the user to select the type of container. The user can then select the desired container type. In FIG. 18, it can be seen that several header containers 1602 and text containers 1604 have been selected and positioned on the document 1510. The containers can then be moved as desired.

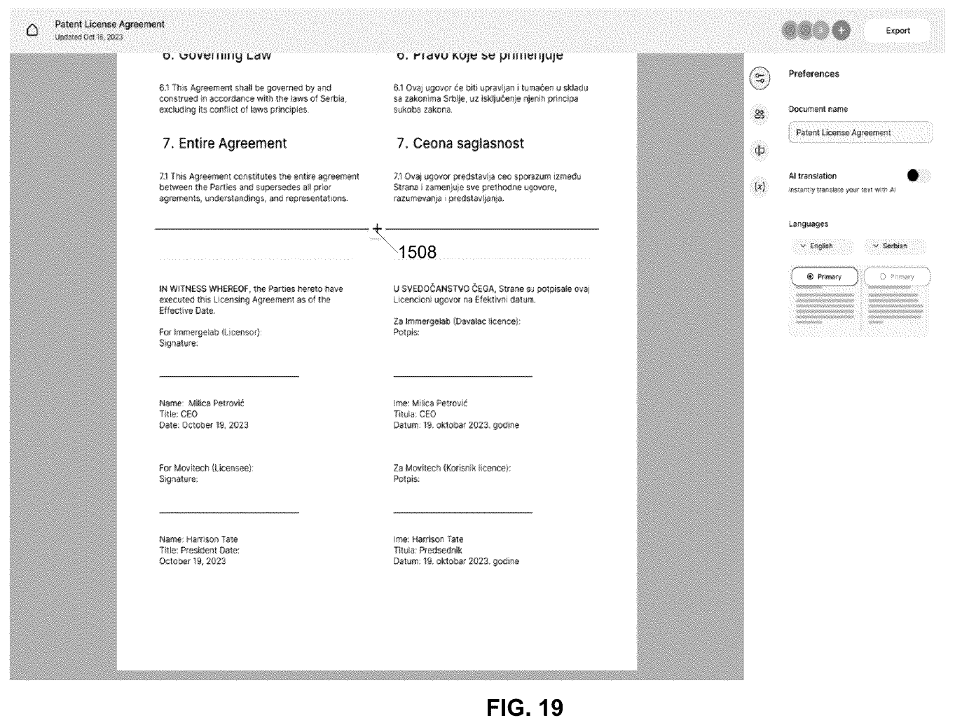

As illustrated in FIG. 19, the add button 1508 can appear between each container allowing further containers to be added.

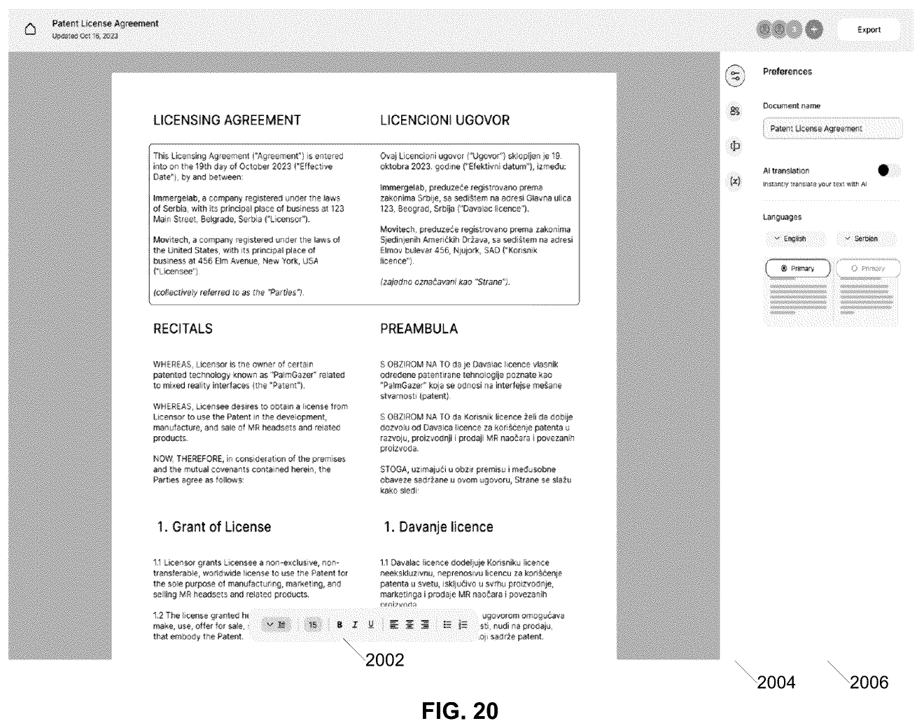

As illustrated in FIG. 20, the user can select a container and a tool bar 2002 can be displayed allowing for editing and possibly the ability to change the container type.

Returning to FIG. 16, when a user selects and places a header or text container, they can then begin typing in the primary language on the primary side, in this example the left side. A translation engine included in application 112 and/or 132, receives the text and automatically translates it and populates the right side in the secondary language. Thus, a user, who may only speak the primary language can generate the entire document quickly and easily. The text can then be edited in the primary, and depending on the implementation the secondary language and those edits will carry through to the other language/side. The translation engine can be configured to suggest language to be used, based on added text that may make more sense or translate easier or better in the other language. Such suggestion can be displayed in an overlay window (not shown) and can be easily accepted by, e.g., clicking on the window, or hitting a key like the TAB key, etc. Edits can be made by collaborators with editing permission as explained below.

In certain embodiments, instead of picking and placing containers, moving them around, adding text, etc., the user can simply pick a template for a particular type of document. Application 112 and/or 132 can then generate a template document with containers preselected and arranges the user can add their text. Moreover, in certain embodiments, the user can simply upload, or scan a copy of an existing agreement in one language, e.g., select a template, indicate the other language, as well as which language is primary, etc., and application 112 and/or 132 can generate the entire document with translations. Again, the user can be allowed to edit, review suggested language changes, etc.

Sticking with FIG. 20, it can be seen that the user interface can comprise panel 2004 that includes for tabs, in this example the preference tab, collaborator tab, review tab and variable tab. Various option can then appear in window 2006. Thus, as illustrated in FIG. 20, when the preference tab is selected. Window 2006 can be populated with the name of the document, a radio button to turn off and on translation capabilities, which will be discussed in more detail below, and the ability to set or change the language for both the primary portion, and the secondary portion.

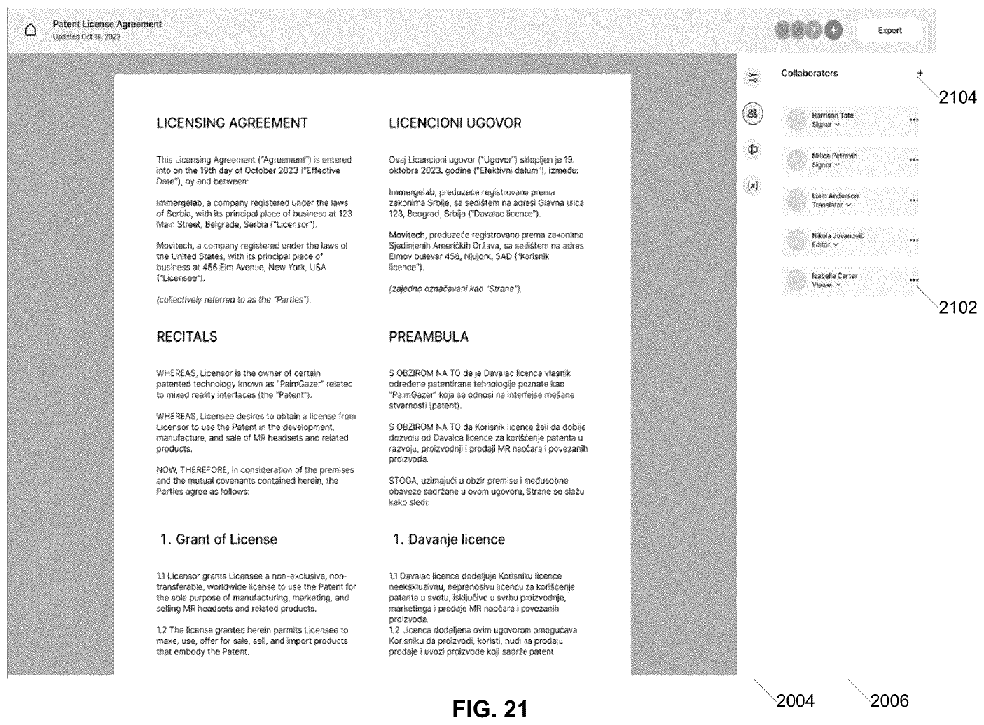

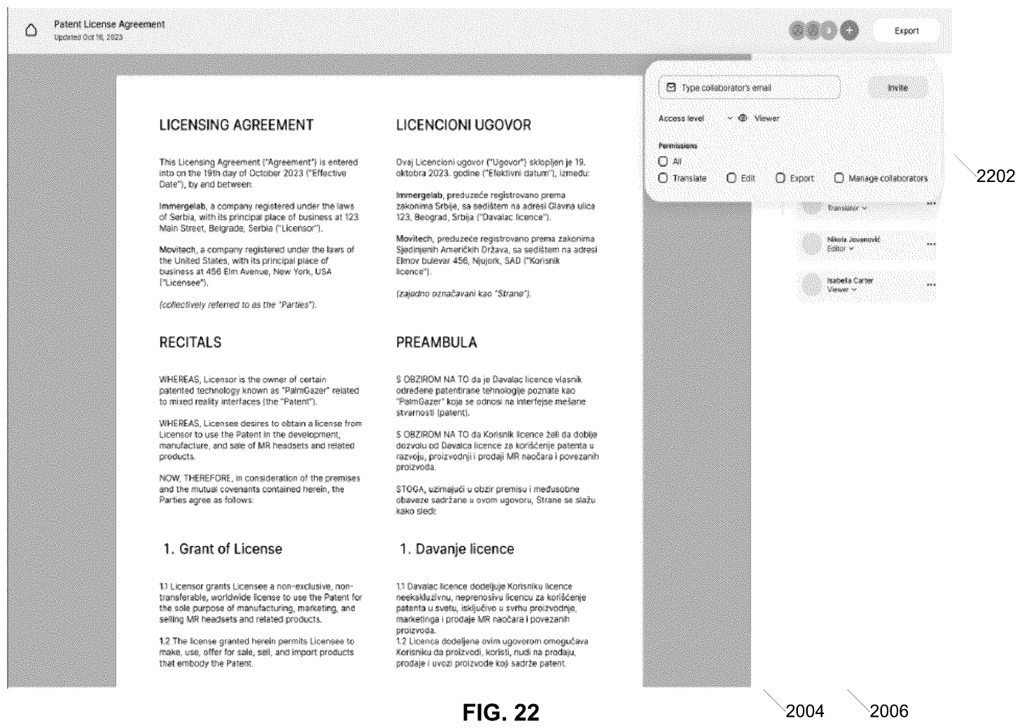

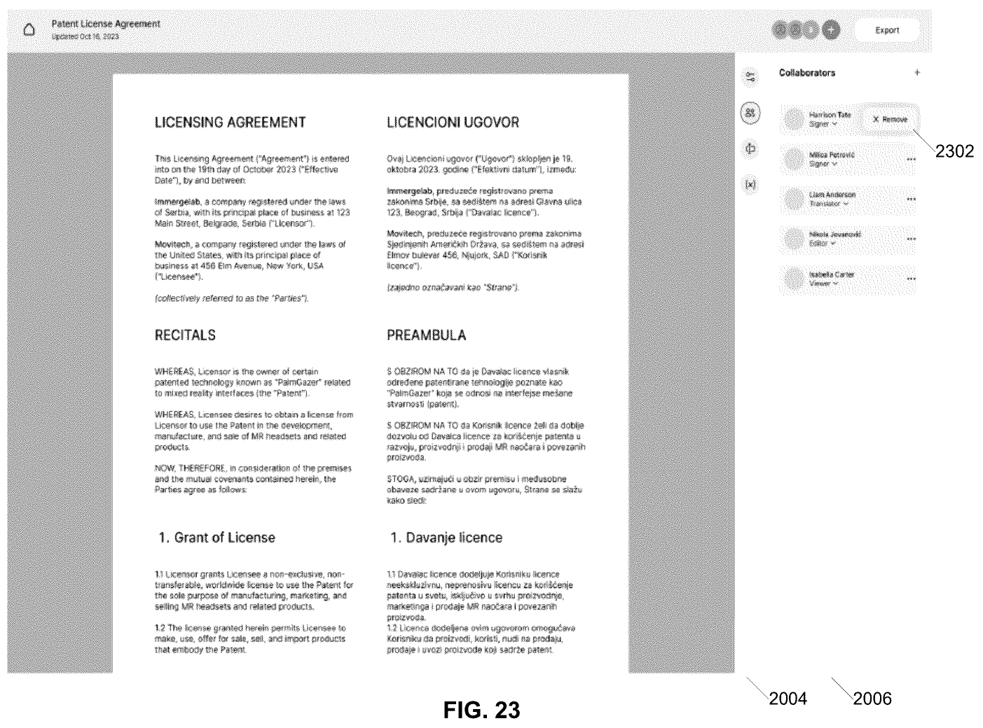

As illustrated in FIG. 21, when the collaborator tab is selected, then a list of current collaborators, which may have been set up at the time of document creation can be displayed in window 2006. A “+’ button 2104 can be included to easily add new collaborators as illustrate din FIG. 22. As can be seen, when button 22 is activated, a window 2202 can appear that can enable the user to set the new collaborator's access level, e.g., owner, editor, translator, viewer etc., as well as the permissions, e.g., translate, edit, export, manage collaborators, or all. The collaborator names can also have some for of input mechanism, in this case the ellipses 2102 that can be selected or activated in order to remove a collaborator. Thus, selecting the ellipses 2102 can present the user with a button 2302 to remove the collaborator. In certain embodiments, only an owner can add and remove collaborators.

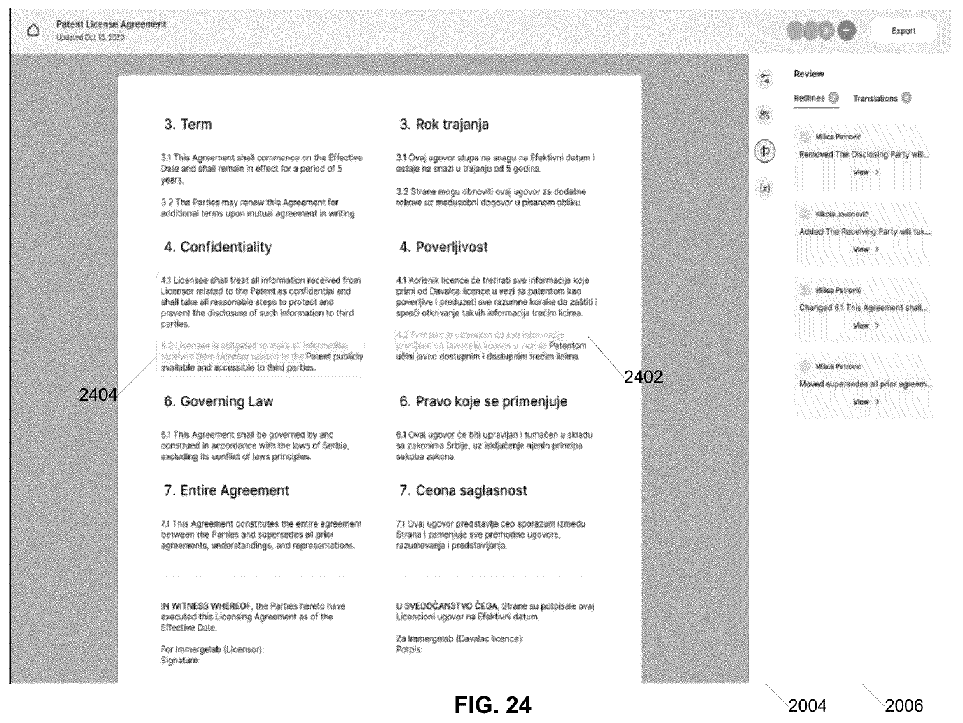

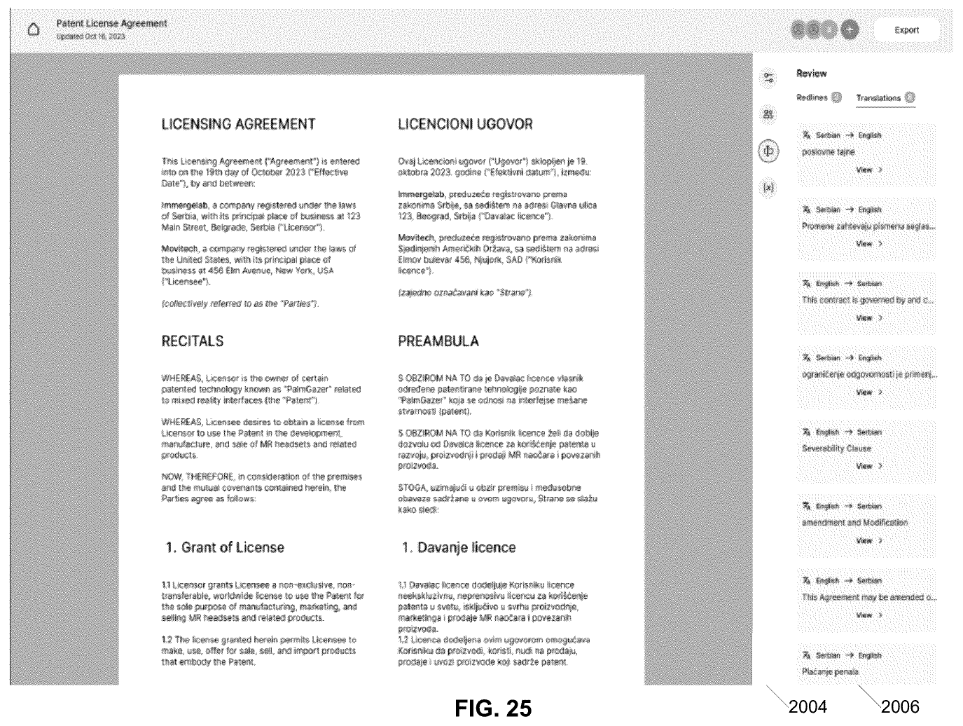

As illustrated in FIG. 24, when the review tab is selected recent redlines and translation activity can be displayed in window 2006. In this implementation, the user can toggle between redlines (FIG. 24) and translations (FIG. 25). Text can be added, changed/edited, removed, and/or moved. In each instance, the edited text 2404 and 2406 can be made to standout, e.g., via different colored text. Other techniques can be used, such as different font, size, bolding, underlining, italicizing or some combination of all of the above. In certain implementations, the edited text can stand out differently on the primary and secondary sides, such as with different color text on one side versus the other. And of course, if text was deleted, it can be shown lined out to indicate such.

Again, as noted above, when text is changed or added, the translation engine implemented by application 112/132 can automatically translate the changes to the other side. In certain embodiments, the translation can even suggest a change to the edit, or addition that would make more sense, or be easier to translate in the other language. Such suggestions can be displayed and accepted as described above.

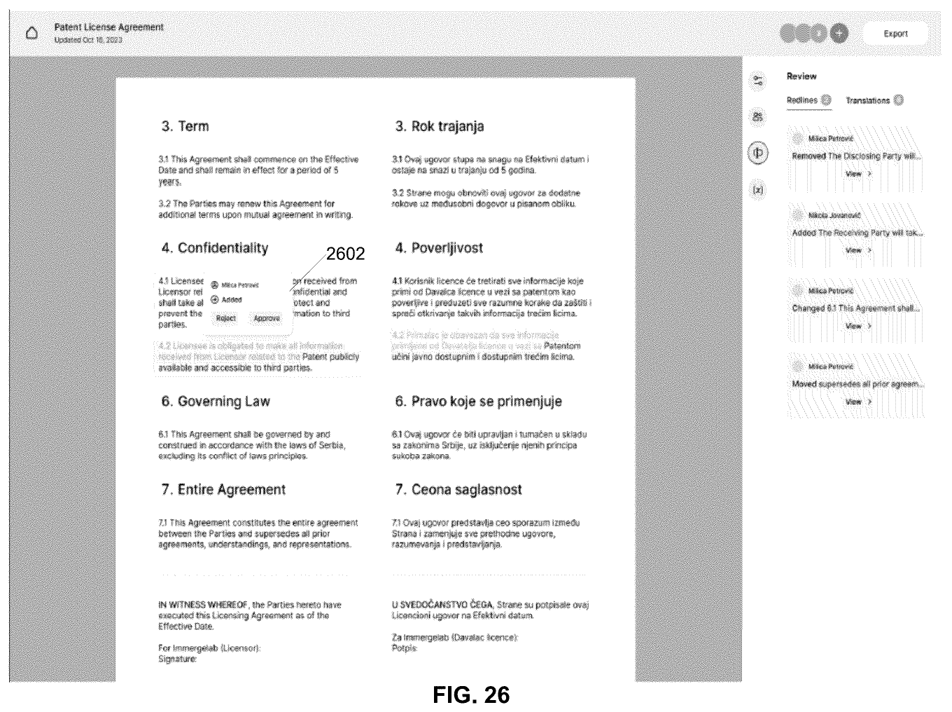

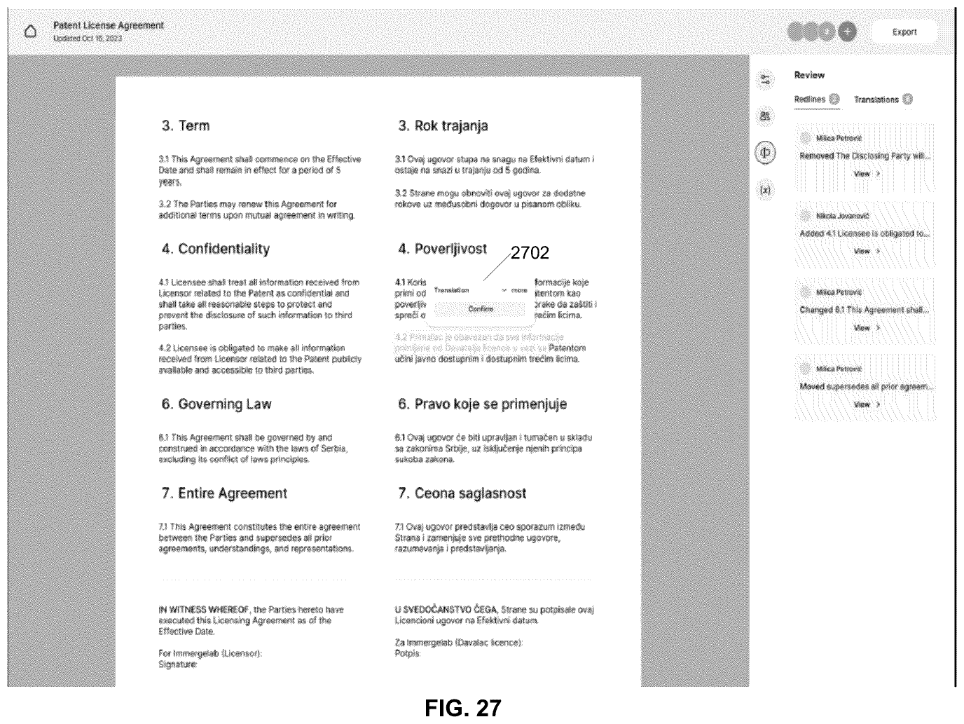

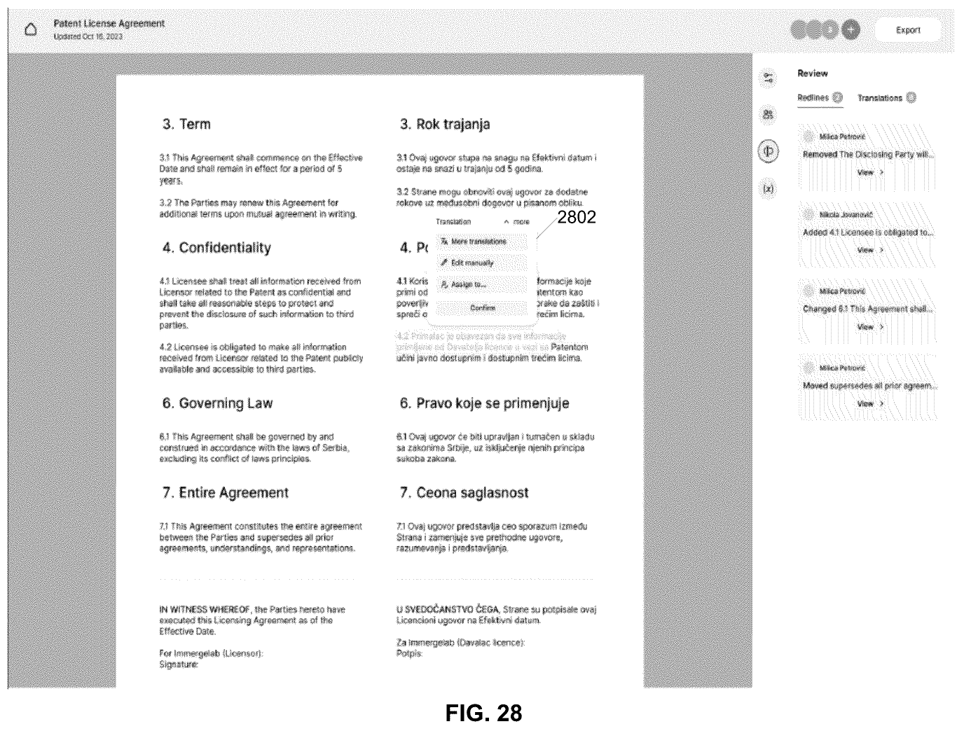

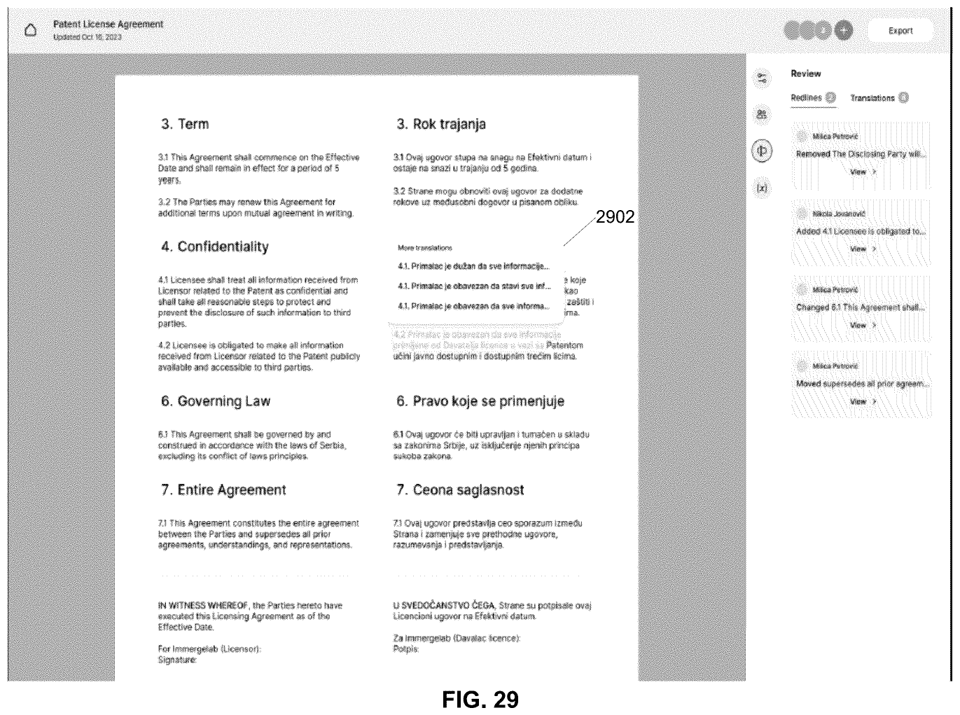

As illustrated in FIG. 26, when the user, e.g., hovers the cursor over or taps the edited text, a window 2602 can be presented to allow the user to reject or approve the changes. If the edit to the first, in this case primary language is accepted, then a window 2702 (FIG. 27) can present to allow the user to confirm the translation. Alternatively, the user can access more options, e.g., via selecting more in window 2702. As illustrated in FIG. 28, when the more option is selected, a widow 2802 can be presented with options, such as more translations, edit manually, or assign the translation approval. If the more translations option is selected, then the translation engine can suggest further translation and present them, e.g., via window 2902 (FIG. 29). The user can then select one of the further translations. If the user selects edit manually, then the user can be given the option to edit the text themselves, although again the translation engine can be configured to make suggestions still as described.

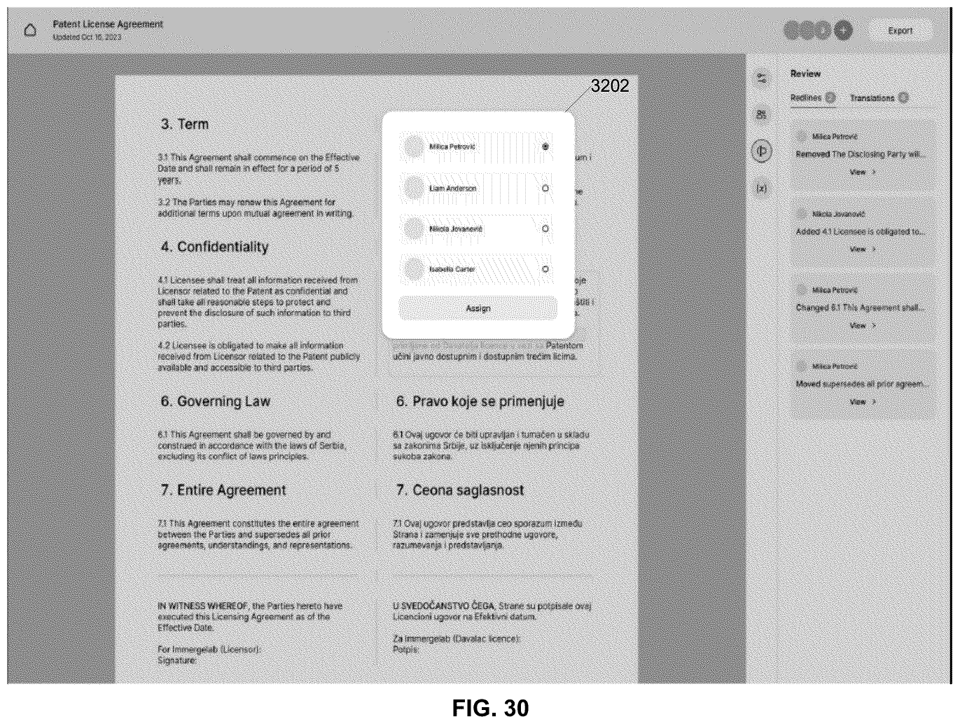

If the user elects to assign the translation approval to a collaborator, then a window 3002 (FIG. 30) can appear with a list of collaborators to select from.

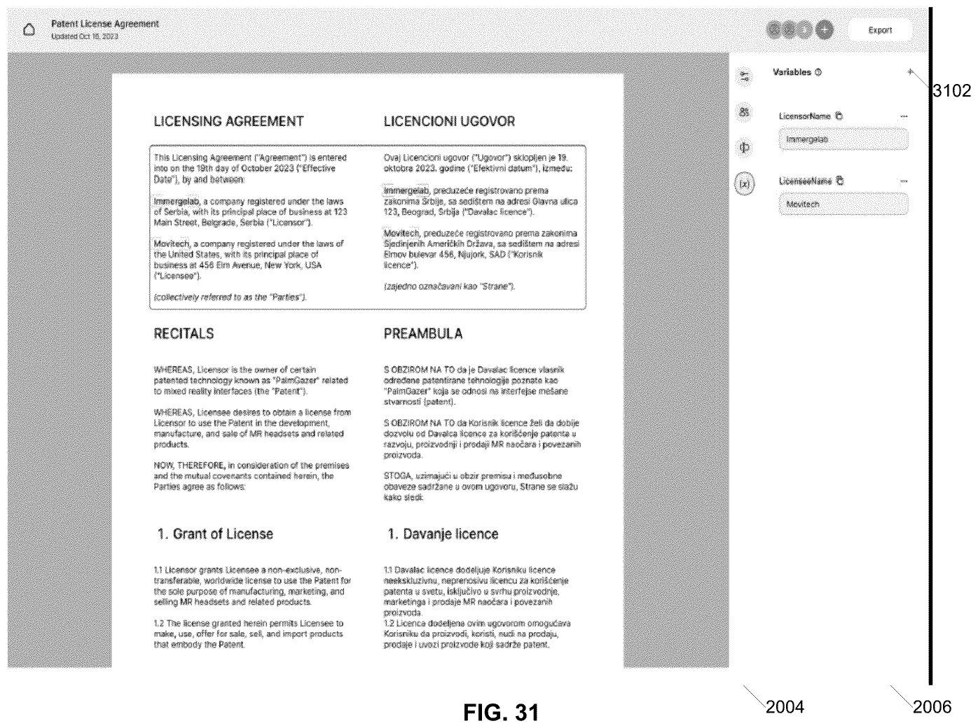

As illustrated in FIG. 31, if the user selects the variables tab in, then the user can set up variables for certain repeat text in window 2006. This would typically be for text that is repeated throughout the document. In the example, of FIG. 31, for example, variables are set up for LicenseeName and LicensorName. As the user is typing, they can insert the variable by, e.g., hitting the copy (or some other designated) key, or typing # or some other symbol and then typing the variable name. Variables can be added by hitting the “+” button/sign 3102 in window 2006. Thus, the user would hit add, name the variable, and then type in the corresponding text for the variable. In certain embodiments, the length in terms of words for a variable can be limited.

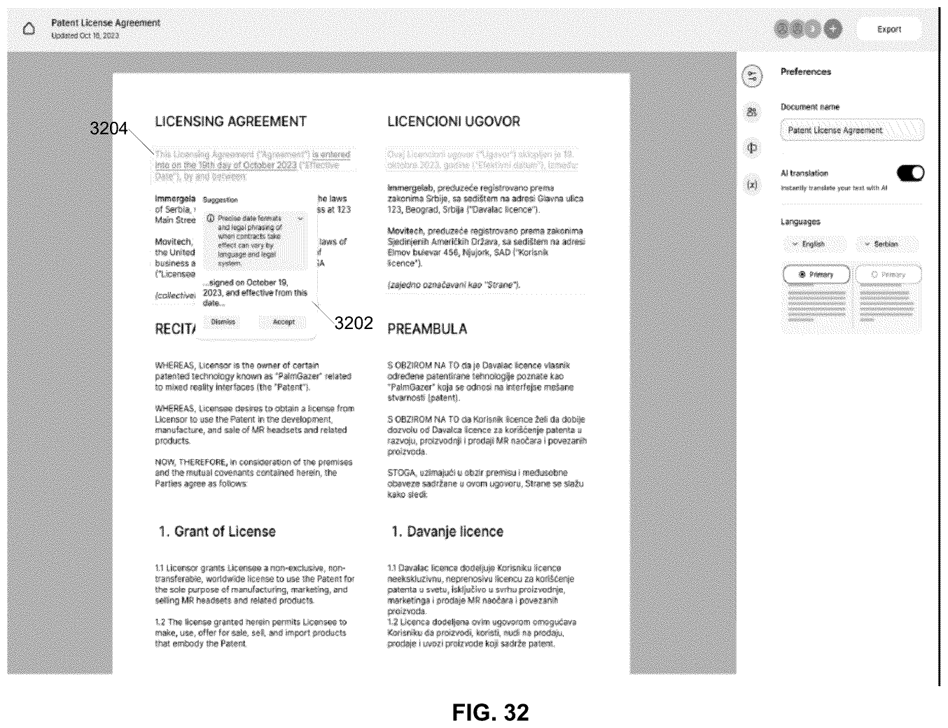

Certain embodiments can have a suggestion engine implemented by application 112/132 that can highlight certain text 3204 and make suggestions, e.g., through a window 3202 (FIG. 32) for, e.g., format. Window 3202 can include a rational for the suggestion, such as formatting a date a certain way because dates can be important. The suggestion engine may not actually suggest any changes, but may just highlight text or items that may deserve extra attention, such as a date. The user can accept or dismiss eh suggestion as illustrated.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive instruction to generate a particular type of document comprising a plurality of containers, and wherein the document has a primary language and a secondary language;
generate the document with the plurality of containers;
receive text in either the primary language for certain of the plurality of containers;
populate the text into the corresponding containers of the plurality of containers;
automatically translate the text into the secondary language and populate the translated text into the corresponding containers of the plurality of containers; and
present the test to a user via a user interface for review and editing.

2. The method of claim 1, further comprising presenting the user with suggestions via the user interface for deferent wording of text in the primary language that will translate better.

3. The method of claim 1, further comprising presenting the user with at least one alternative translations via the user interface, and receiving a selection of one of the at least one alternative translations.

4. The method of claim 1, further comprising receiving edits to the text in the primary language, and automatically translating the edits into the text in the second language.

5. The method of claim 4, further comprising presenting the user with suggestions via the user interface for deferent wording of text in the primary language that will translate better.

6. The method of claim 4, further comprising presenting the user with at least one alternative translations via the user interface, and receiving a selection of one of the at least one alternative translations.

7. The method of claim 1, wherein receive text in either the primary language comprises receiving text typed in via the user interface, receiving a scan of the text, receiving an image of the text, or otherwise receiving an upload of the text.
